(19) United States
(12) Patent Application Publication
(10) Pub. No.: US 2025/0071731 A1
(43) Pub. Date: Feb. 27, 2025

(54) METHOD FOR OPERATING COMMUNICATION DEVICES FOR PAGING, AND COMMUNICATION DEVICES THEREFOR

(71) Applicants: SAMSUNG ELECTRONICS CO., LTD., Suwon-si (KR); RESEARCH & BUSINESS FOUNDATION SUNGKYUNKWAN UNIVERSITY, Suwon-si (KR); SK TELECOM CO., LTD., Seoul (KR)

(72) Inventors: Bokkeun KIM, Suwon-si (KR); Hyun Seung CHOO, Suwon-si (KR); Dong Jin LEE, Seoul (KR); Hyun Jun CHOI, Seoul (KR); Joong Gunn PARK, Seoul (KR)

(21) Appl. No.: 18/941,500

(22) Filed: Nov. 8, 2024

Related U.S. Application Data
(63) Continuation of application No. PCT/KR2023/006345, filed on May 10, 2023.

(30) Foreign Application Priority Data
May 10, 2022 (KR) 10-2022-0057353
Jul. 20, 2022 (KR) 10-2022-0089857

(51) Int. Cl. H04W 68/02; H04W 8/02

(52) U.S. Cl. CPC H04W 68/02; H04W 8/02

(57) ABSTRACT

In a method for operating data analysis devices, including first data analysis devices distributed in a network and a centralized second data analysis device, according to an embodiment, the first data analysis devices collects mobility data of a user terminal from mobility management devices in the network, the second data analysis device preprocesses the mobility data, the second data analysis device applies the preprocessed mobility data to a prediction model based on a neural network and trains the prediction model to predict base stations serving a target location to which the user terminal is predicted to move by the prediction model, and the trained prediction model and identification information about the user terminal can be transferred to the first data analysis devices.

### CROSS-REFERENCE TO RELATED APPLICATIONS

This application is a continuation of International Application No. PCT/KR2023/006345 designating the United States, filed on May 10, 2023, in the Korean Intellectual Property Receiving Office and claiming priority to Korean Patent Application Nos. 10-2022-0057353, filed on May 10, 2022, and 10-2022-0089857, filed on Jul. 20, 2022, in the Korean Intellectual Property Office, the disclosures of each of which are incorporated by reference herein in their entireties.

### BACKGROUND

### Field

The disclosure relates to a method for operating communication devices for paging, and the communication devices therefor.

### Description of Related Art

In a mobile network, a base station may repeatedly disconnect and reconnect wireless connections to reduce the power consumption of user equipment (UE) and conserve radio resources. For example, a base station in a 5G network, such as a next generation node B (gNB), may disconnect the connection between the base station and a UE when there is no traffic between the UE and the base station for a period of time. As the connection to the base station is released, an operating mode of the UE may change from an active mode to an idle mode. When there is downlink data to be transmitted to the UE in idle mode, an access and mobility management function (AMF) device may transmit paging messages to multiple base stations to locate the UE.

Paging may cause a lot of signaling traffic in a core network. For example, as cells become progressively smaller in size, such as in 5G networks, more signaling for paging may occur, which may be expensive. In addition, a delay due to paging may make it difficult to satisfy services with high latency requirements, such as ultra-reliable low latency communications (URLLC), for example.

### SUMMARY

Embodiments of the disclosure provide a prediction model that predicts the mobility of a user equipment (UE) suitable for paging and may be trained by applying location information on a location to which the UE has moved in the active mode, as well as a time elapsed by the UE in the idle mode, considering that the location of the UE changes depending on the time the UE has been in the idle mode.

Embodiments of the disclosure provide a trained prediction model where the mobility data of the UE may be applied to the trained prediction model to predict a location of the UE for paging, and paging may be performed by a base station serving the predicted location.

Embodiments of the disclosure provide a paging system in which a ratio of base stations to be used for multi-level paging may be adjusted by determining a paging service type corresponding to the UE based on the type of service and/or billing policy of the UE.

According to an example embodiment, a method for operating a data analysis device including first data analysis devices distributed within a network and a centralized second data analysis device may include: the first data analysis devices collecting mobility data of a user equipment (UE) from mobility management devices in the network, the second data analysis device preprocessing the mobility data, the second data analysis device applying the preprocessed mobility data to a neural network-based prediction model to train the prediction model to predict base stations serving a target location to which the UE is expected to move, and transferring the trained prediction model and identification information of the UE to the first data analysis devices.

According to an example embodiment, a method for operating a mobility management device may include: transmitting mobility data of a user equipment (UE) to a first data analysis device distributed within a network, the first data analysis device including a neural network-based trained prediction model, receiving the base station list including base stations serving a target location to which the UE is expected to move, predicted by the first data analysis device by applying the mobility data to the prediction model, determining a target base station to perform per-level paging of multi-level paging among the base stations included in the base station list, and performing the multi-level paging for the UE by the target base station.

According to an example embodiment, a data analysis device including first data analysis devices distributed within a network and a centralized second data analysis device may include: a communication interface, comprising communication circuitry, configured to collect mobility data of a user equipment (UE) from mobility management devices in the network, and at least one processor, comprising processing circuitry, individually and/or collectively, configured to: preprocess mobility data, and apply the preprocessed mobility data to a neural network-based prediction model to train the prediction model to predict base stations serving a target location to which the UE is expected to move, and the communication interface may be configured to transfer the base station list predicted by the trained prediction model and identification information of the UE to the mobility management devices.

According to an example embodiment, the mobility management device may include: a communication interface, comprising communication circuitry, configured to transmit mobility data of a user equipment (UE) to a first data analysis device distributed within a network, the first data analysis device including a trained neural network-based prediction model, and receive a base station list including base stations serving a target location to which the UE is expected to move, predicted by the first data analysis device by the prediction model based on the mobility data, and at least one processor, comprising processing circuitry, individually and/or collectively, configured to determine a target base station to perform per-level paging of multi-level paging among the base stations and perform the multi-level paging for the UE by the target base station.

A communication device according to various example embodiments may predict the mobility of the UE suitable for paging with higher accuracy by training a neural network-based prediction model by reflecting an elapsed time in idle mode of the UE.

The communication device according to various example embodiments may reduce signaling traffic and/or latency due to paging by performing multi-level paging by base stations predicted using the trained prediction model.

The communication device according to various example embodiments may provide a paging service tailored to the service required by the UE, by determining the paging service type corresponding to the UE based on the type of service and/or billing policy of the UE and by adjusting a proportion of base stations performing per-level paging for the multi-level paging according to the paging service type.

In addition, various effects directly or indirectly ascertained through the present disclosure may be provided.

### BRIEF DESCRIPTION OF THE DRAWINGS

The above and other aspects, features and advantages of certain embodiments of the present disclosure will be more apparent from the following detailed description, taken in conjunction with the accompanying drawings, in which:

FIG. 1 is a diagram illustrating an example configuration of a 5G mobile communication system, according to various embodiments;

FIG. 2 is a diagram illustrating example tracking area (TA) and a tracking area identifier (TAI) in a 5G mobile communication system, according to various embodiments;

FIG. 3 is a diagram illustrating an example multi-level paging method;

FIG. 4 is a diagram illustrating an example paging method to which mobility prediction of a user equipment (UE) is applied, according to various embodiments;

FIG. 5 is a flowchart illustrating an example method of operating a data analysis device, according to various embodiments;

FIG. 6 is a diagram illustrating an example process of preprocessing mobility data, according to various embodiments;

FIG. 7 is a diagram illustrating an example structure and an example operation of a neural network-based prediction model, according to various embodiments;

FIG. 8 is a flowchart illustrating an example method of operating a mobility management device, according to various embodiments;

FIG. 9 is a diagram illustrating example multi-level paging methods, according to various embodiments;

FIG. 10 is a diagram illustrating an example operation of an offline training process and an online prediction process between a data analysis device and a mobility management device, according to various embodiments;

FIG. 11 is a block diagram illustrating an example configuration of a data analysis device, according to various embodiments;

FIG. 12 is a block diagram illustrating an example configuration of a mobility management device, according to various embodiments; and

FIG. 13 is a block diagram illustrating an example electronic device, in a network environment, according to various embodiments.

### DETAILED DESCRIPTION

Hereinafter, various example embodiments will be described in greater detail with reference to the accompanying drawings. When describing various embodiments with reference to the accompanying drawings, like reference numerals refer to like elements and a repeated description related thereto will be omitted.

The electronic device according to various embodiments disclosed herein May be one of various types of electronic devices. The electronic device may include, for example, a portable communication device (e.g., a smart phone), a computer device, a portable multimedia device, a portable medical device, a camera, a wearable device, a home appliance device, or the like. According to an embodiment of the disclosure, the electronic device is not limited to those described above.

It should be appreciated that various embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, “A or B,” “at least one of A and B,” “at least one of A or B,” “A, B or C,” “at least one of A, B and C,” and “at least one of A, B, or C,” may include any one of the items listed together in the corresponding one of the phrases, or all possible combinations thereof. Terms such as “1st” and “2nd,” or “first” and “second” may be used to simply distinguish a corresponding component from other components, and do not limit the components in other aspects (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), the element may be coupled with the other element directly (e.g., by wire), wirelessly, or via a third element.

As used in connection with embodiments of the disclosure, the term “module” may include a unit implemented in hardware, software, or firmware, or any combination thereof, and may interchangeably be used with other terms, for example, “logic”, “logic block”, “part”, or “circuitry”. A module may be a single integral component, or a minimum unit or part thereof, adapted to perform one or more functions. For example, according to an embodiment, the module may be implemented in a form of an application-specific integrated circuit (ASIC).

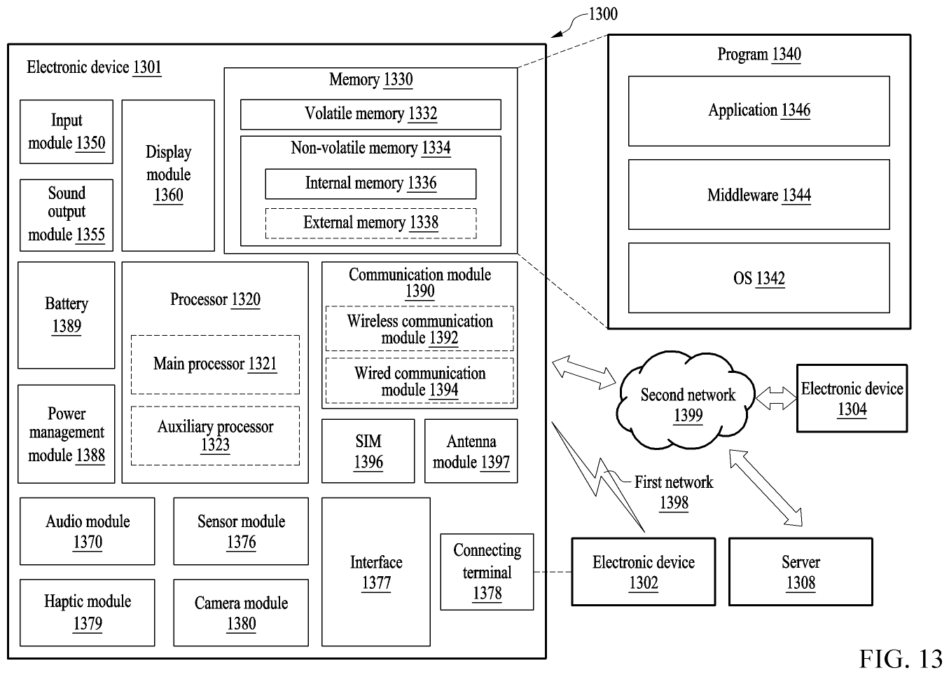

An embodiment as set forth herein may be implemented as software (e.g., a program 1340) including one or more instructions that are stored in a storage medium (e.g., internal memory 1336 or external memory 1338) that is readable by a machine (e.g., an electronic device 1301 of FIG. 13). For example, a processor (e.g., a processor 1320) of the machine (e.g., the electronic device 1301) may invoke at least one of the one or more instructions stored in the storage medium, and execute it. This allows the machine to be operated to perform at least one function according to the at least one instruction invoked. The one or more instructions may include code generated by a compiler or code executable by an interpreter. The machine-readable storage medium may be provided in the form of a non-transitory storage medium. Here, the “non-transitory” storage medium is a tangible device, and may not include a signal (e.g., an electromagnetic wave), but this term does not differentiate between where data is semi-permanently stored in the storage medium and where the data is temporarily stored in the storage medium.

According to an embodiment, a method according to embodiments of the disclosure may be included and provided in a computer program product. The computer program product may be traded as a product between a seller and a buyer. The computer program product may be distributed in the form of a machine-readable storage medium (e.g., compact disc read-only memory (CD-ROM)), or be distributed (e.g., downloaded or uploaded) online via an application store (e.g., PlayStore™), or between two user devices (e.g., smartphones) directly. If distributed online, at least part of the computer program product may be temporarily generated or at least temporarily stored in the machine-readable storage medium, such as memory of the manufacturer's server, a server of the application store, or a relay server.

According to an embodiment, each component (e.g., a module or a program) of the above-described components may include a single entity or multiple entities, and some of the multiple entities may be separately disposed in different components. According to an embodiment, one or more of the above-described components may be omitted, or one or more other components may be added. Alternatively or additionally, a plurality of components (e.g., modules or programs) may be integrated into a single component. In such a case, according to embodiments, the integrated component may still perform one or more functions of each of the plurality of components in the same or similar manner as they are performed by a corresponding one of the plurality of components before the integration. According to an embodiment, operations performed by the module, the program, or another component may be carried out sequentially, in parallel, repeatedly, or heuristically, or one or more of the operations may be executed in a different order or omitted, or one or more other operations may be added.

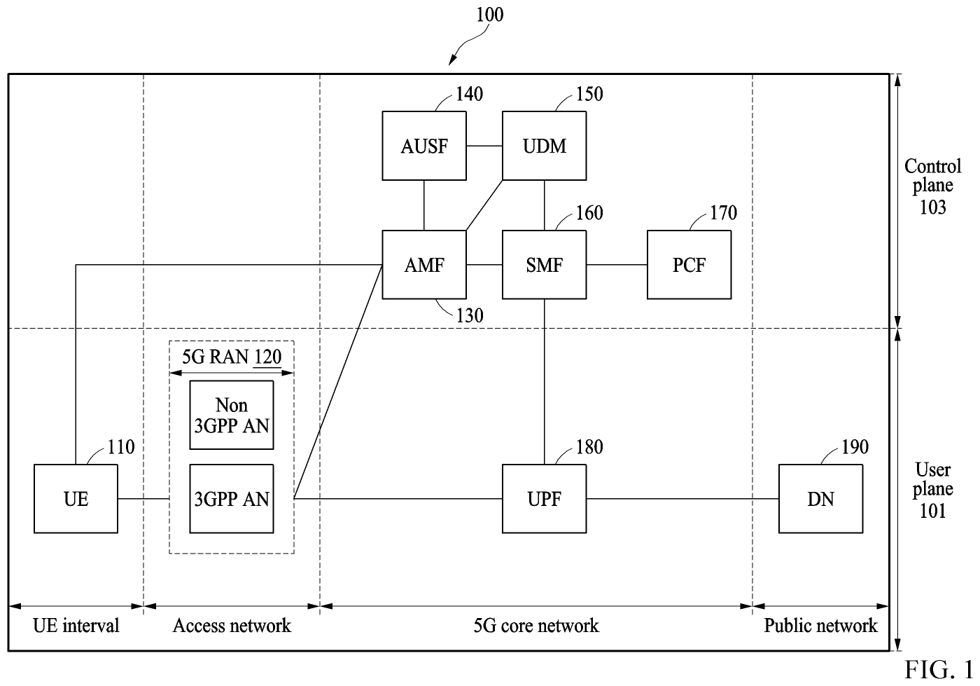

FIG. 1 is a diagram illustrating an example configuration of a 5G mobile communication system, according to various embodiments. Referring to FIG. 1, a 5G mobile communication system 100 may include, for example, a user equipment (UE) 110 (e.g., the electronic device 1301 of FIG. 13), a 5G radio access network (RAN) 120, an access and mobility management function (AMF) 130, an authentication server function (AUSF) 140, a user data management (UDM) 150, a session management function (SMF) 160, a policy control function (PCF) 170, a user plane function (UPF) 180, and a data network (DN) 190, but is not necessarily limited thereto. Hereinafter, the 5G RAN 120 may include a base station. Each of the referenced functions may include various circuitry and/or executable program instructions.

In the 5G mobile communication system 100, each of the components and a connection interface therebetween may be defined based on a network function (NF) basis. This allows the functions of each component to be implemented with physical network equipment or network resources through virtualization. When a 5G subscriber first connects to a 5G network via the UE 110, the AMF 130 may perform authentication of the UE 110 with authentication data of the subscriber stored in the AUSF 140. In this case, in addition to subscriber authentication, the AMF 130 may also be responsible for mobility management to support uninterrupted communication when the UE 110 moves to a cell area of a different base station. At least a portion of other subscription information, plans, and billing policies may be managed separately through a database, e.g., the UDM 150.

After subscriber authentication, the UE 110 may establish a connection via a wireless channel with the 5G RAN 120, which is a base station in a current cell area, and finally connect with the DN 190 corresponding to the Internet network via the UPF 180. Here, the DN 190 may include the Internet, and the UPF 180 may serve as a gateway for finally transferring a packet via the 5G RAN to the DN 190.

When the UE 110 connected to the DN 190 is provided with multiple multi-services simultaneously, the UE 110 may have multiple connection sessions. In this case, the SMF 160 may be assigned to each session and each session may be managed so that service is not interrupted due to a disconnection of each session. The PCF 170 may determine and implement policies for session management via the SMF 160 and mobility management via the AMF 130. The policies for mobility and session management may be determined via the PCF 170, and each policy may be transferred from the PCF 170 to the AMF 130 and the SMF 160 for implementation.

The UE 110, the 5G RAN 120, the UPF 180, and the DN 190, which are areas where actual data flows, may be referred to as a “user plane” 101, and the AMF 130, the AUSF 140, the UDM 150, the SMF 160, and the PCF 170, which are areas for the control and management of the 5G mobile communication system 100, may be referred to as a “control plane” 103.

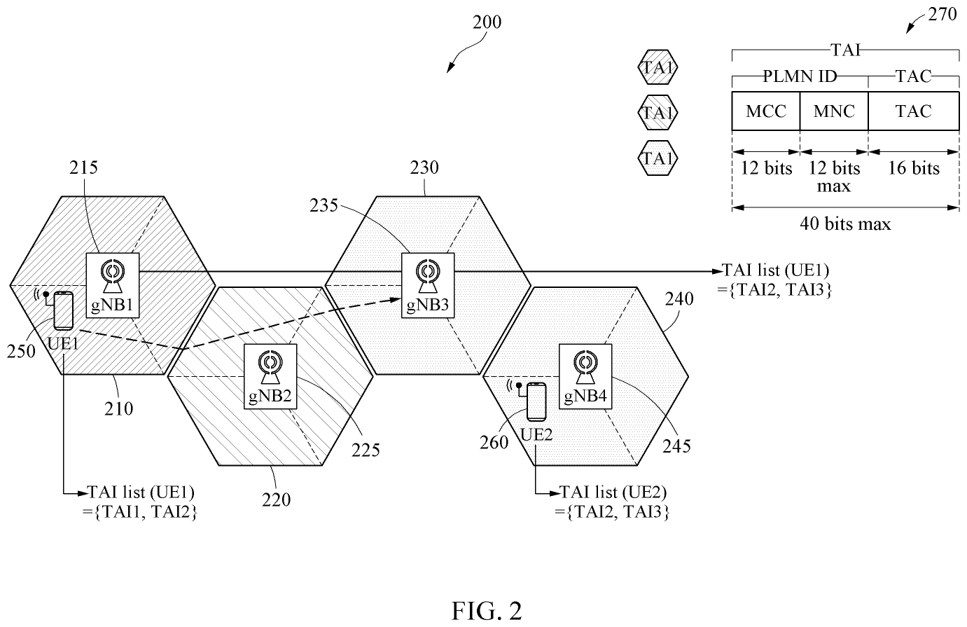

FIG. 2 is a diagram illustrating an example tracking area (TA) and an example tracking area identifier (TAI) in a 5G mobile communication system, according to various embodiments. Referring to FIG. 2, a diagram 200 of a process by which UEs 250 and 260 (e.g., the UE 110 of FIG. 1 and/or the electronic device 1301 of FIG. 13) move to respective cells 210, 220, 230, and 240 served by base stations 215, 225, 235, and 245 is illustrated.

For example, when the UEs 250 and 260 are in an active state in which communication is being performed, a network may identify a location of the UEs 250 and 260 on a cell basis. When the UEs 250 and 260 are in an idle state in which communication is not being performed, the network may identify the location of the UEs 250 and 260 on a TA basis rather than a cell basis. A single TA may be a group of a plurality of neighboring base stations, and each of the base stations 215, 225, 235, and 245 may know which TA the base stations 215, 225, 235, and 245 belong to.

For example, when downlink traffic directed to the UEs 250 and 260 occurs while the UEs 250 and 260 are in the idle state, the network may transmit a paging message to the UEs 250 and 260. In this example, the network may transmit a paging message to the base stations in the TA to which the UEs 250 and 260 belong, and each of the base stations may wake up the UEs 250 and 260 in the idle state by transmitting the paging message to the base stations' coverage, e.g., an area served by each base station.

A TAI 270 may include a unique identifier that identifies a TA, and may include, for example, a public land mobile network (PLMN) ID and a TAI. The PLMN ID may be a unique network identifier assigned to a mobile communication service provider, and may include a mobile country code (MCC) and a mobile network code (MNC). The TAI 270 may have a unique value assigned to each TA by the mobile communication service provider.

For example, the first cell 210 may correspond to TAI, the second cell 220 may correspond to TA2, and the third cell 230 and the fourth cell 240 may correspond to TA3. The first cell 210 may be served by the first base station gNB1 215, and the second cell 220 may be served by the second base station gNB2 225. In addition, the third cell 230 may be served by the third base station gNB3 235, and the fourth cell 240 may be served by the fourth base station gNB4 245.

When the TA changes as the first UE (UE 1) 250 moves through the first cell 210, the second cell 220, and the third cell 230, the first UE (UE 1) 250 may report a registration request message to the network indicating that the TA has changed. In response to the registration request message, the first UE 250 may receive a list of TAIs, for example, {TAI1, TAI2}, from the network. In this case, the first UE 250 may not send a registration request message when moving between TA1 and TA2 included in the TA list, but may send a registration request message when moving to a location other than TA1 and TA2 (e.g., TA3). When the first UE 250 moves to TA3, the first UE 250 may receive a list of TAIs (for example, {TAI2, TAI3}) from the network and update the list of TAIs based on the location change.

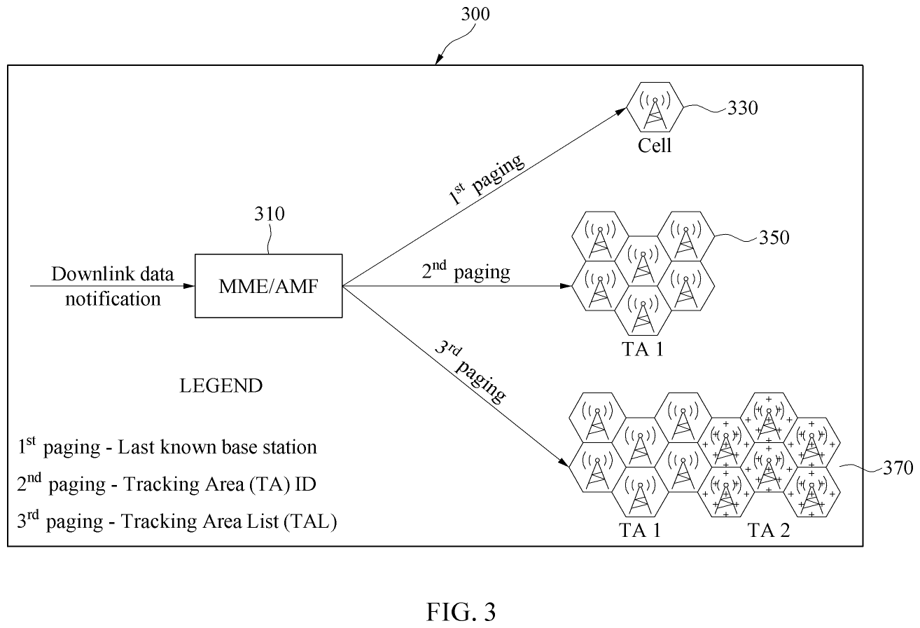

FIG. 3 is a diagram illustrating a typical multi-level paging method. Referring to FIG. 3, a diagram 300 of multi-level paging performed by a mobility management device 310 in a network is illustrated.

Multi-level paging performed by commercial LTE and/or commercial 5G cores may be performed by a mobility management device. The mobility management device 310 may include, for example, an AMFdevice and/or a mobility management entity (MME), but is not necessarily limited thereto.

A multi-level paging method may be performed over three levels, such as level 1 paging (1^{st} paging), level 2 paging (2^{nd} paging), and level 3 paging (3^{rd} paging), as shown in FIG. 3. In each of the three levels, the mobility management device 310 may gradually expand a paging area to base stations, TA, and tracking area lists (TAL) based on a location of a last identified UE (e.g., the UE 110 of FIG. 1, the UEs 250 and 260 of FIG. 2, and/or the electronic device 1301 of FIG. 13).

In the level 1 paging, a paging message may be transmitted to a last known base station 330 of the UE. When the UE is no longer present in a cell of the last known base station 330, the mobility management device 310 may extend the paging area to a TA 350 in the level 2 paging. Similarly, when the level 2 paging also fails, the mobility management device 310 may expand the paging area from the TA 350 to a TAL 370. Paging failures may cause an exponential increase in the number of paging messages that are transmitted redundantly and a linear increase in the delay to localize the UE. Since a 5G mobile network has a greater number of base stations due to smaller cell sizes than a fourth-generation (4G) mobile network, the transmission of redundant paging messages may increase in the 5G mobile network. Thus, signaling traffic and latency may increase as each level of the multi-level paging progresses, as each level of paging incurs a latency equal to the paging response latency when the paging fails.

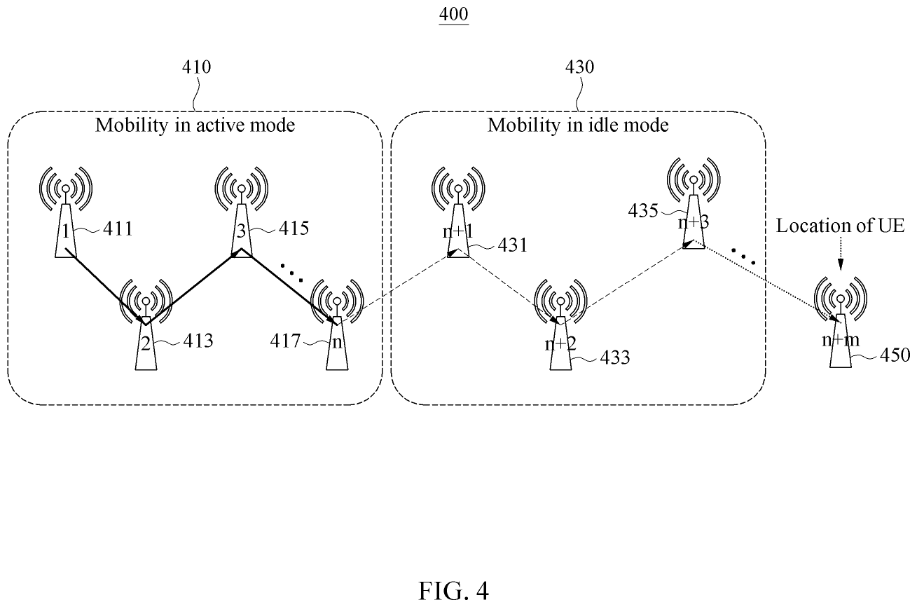

FIG. 4 is a diagram illustrating an example paging method to which mobility prediction of a user equipment (UE) is applied, according to various embodiments.

In a 5G mobile network, a greater number of paging signaling may occur due to a smaller cell size than previous networks, and services with high latency requirements, such as, for example, URLLC, may be included. Therefore, the 5G mobile network may reduce signaling traffic by performing paging by fewer base stations than previous networks, and reduce latency due to paging by achieving higher paging success rates.

Referring to FIG. 4, a diagram 400 of mobility in an active mode 410 and mobility in an idle mode 430 of a UE (e.g., the UE 110 of FIG. 1, the UEs 250 and 260 of FIG. 2, and/or the electronic device 1301 of FIG. 13) according to an embodiment is illustrated.

The mobility of the UE for paging may be determined by predicting a location of the UE at the time of paging by a movement path (e.g., location 1 411->location 2 413->location 3 415-> . . . ->location n 417) of the UE which is identified in the active mode 410 in which the UE performs communication. Alternatively, in the idle mode 430 in which the UE does not perform communication, when a user moves such as, for example, location n+1 431->location n+2 433->location n+3 435-> . . . , location n+m 450 of the UE may vary depending on an elapsed time in the idle mode 430. Thus, when the movement path of the user is predicted without considering the elapsed time in the idle mode 430, the predicted result may not be accurate enough to be applied for paging.

In an embodiment, the mobility of the user may be predicted by learning the elapsed time in the idle mode 430 in addition to the movement path of the UE in the active mode 410 to improve the prediction accuracy of a prediction model while reducing the number of signaling and/or latency of paging. In an embodiment, for example, the elapsed time in the idle mode 430 may be reflected in a machine learning model to predict the mobility of the UE suitable for paging, thereby also predicting the base stations serving the corresponding UE at the time of paging.

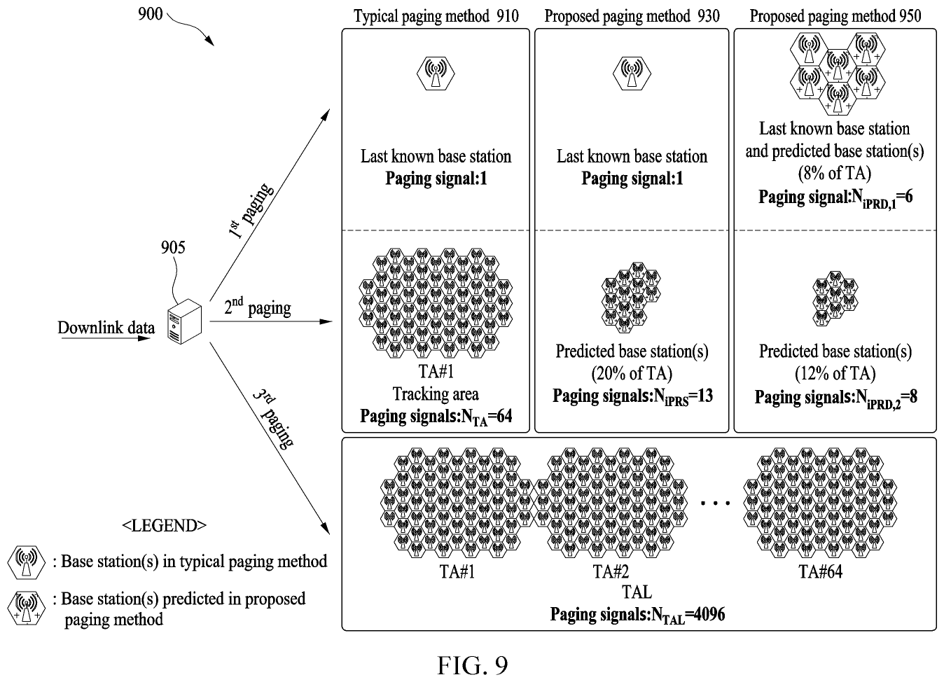

In addition, in an embodiment, depending on whether the paging service type corresponding to the UE is a first service type (iPRS) for reduced signaling or a second service type (iPRD) for reduced delay, a proportion of predicted base stations to be used for each level of multi-level paging may be adjusted to provide signaling traffic and latency tailored to the service type. The paging service types according to an embodiment will be described later with reference to FIG. 9 below.

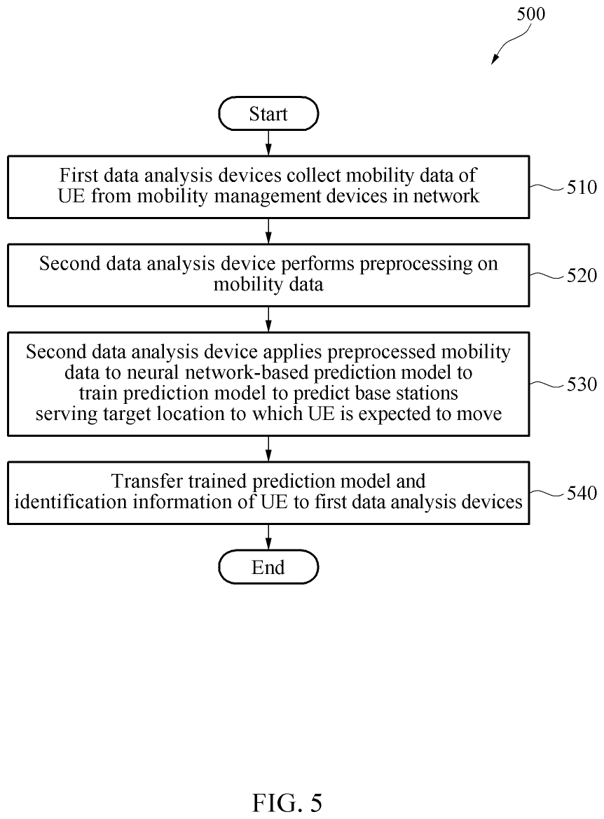

FIG. 5 is a flowchart illustrating an example method of operating a data analysis device, according to various embodiments. In the following embodiments, operations may be performed sequentially, but not necessarily performed sequentially. For example, the order of the operations may be changed and at least two of the operations may be performed in parallel.

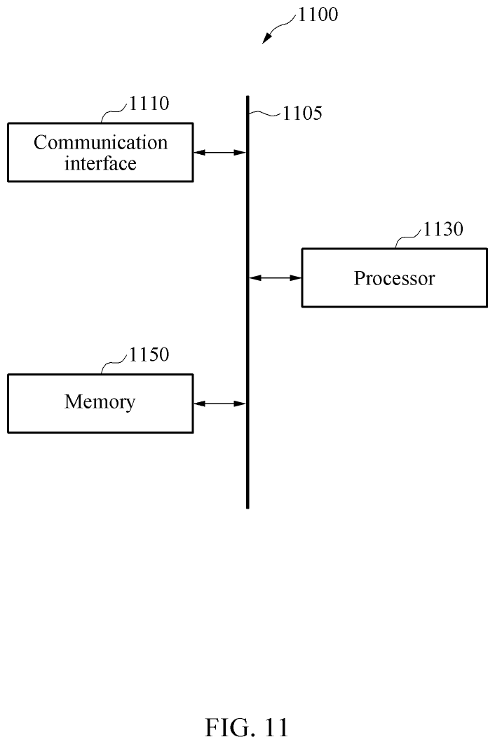

A data analysis device (e.g., a data analysis device 1100 of FIG. 11) may collect network data at the center of an entire network system and analyze the network data. The data analysis device may analyze the network data, for example, for one or more network slices. The data analysis device may collaborate with a network function device in a 5G core network for network instances, which are places where analysis is performed independently by the network function device in the 5G core network. The “network function device” may be a device that performs various functions in the 5G core network.

The network data used in the 5G core network may be input to the data analysis device for data analysis. The data analysis device may utilize existing network services based on other 5G core network functions and an interface for communicating with an operation administration maintenance (OAM) device. The OAM device may be an information provider for the data analysis device or a potential consumer.

Interactions between the data analysis device and the network function devices may be performed by, for example, a local public land mobile network (PLMN). A reporting network function device and the data analysis device may belong to the same PLMN.

The data analysis device may access network data from a data repository such as, for example, a unified data repository (UDR). For the network function devices in the 5G core network, the data analysis device may acquire (collect) network data, analyze the collected network data, and provide an analysis result of the network data to the network function devices and/or the OAM device.

The data analysis device may be, for example, a network data analytics function (NWDAF), but is not necessarily limited thereto. The data analysis device may be located in any device within the 5G core network.

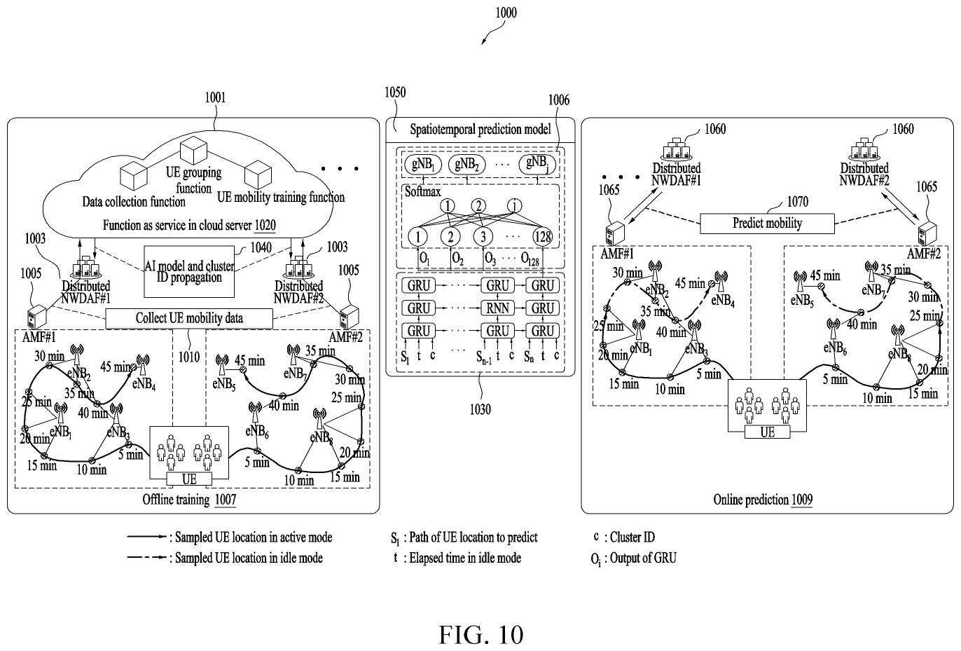

Referring to a flowchart 500 of FIG. 5, the data analysis device according to an embodiment may include first data analysis devices (e.g., first data analysis devices 1003 and 1060 of FIG. 10) distributed within a network and a centralized second data analysis device (e.g., a second data analysis device 1001 of FIG. 10), and may perform operations 510 to 540.

In operation 510, the first data analysis devices may collect mobility data of a UE (e.g., the UE 110 of FIG. 1, the UEs 250 and 260 of FIG. 2, and/or the electronic device 1301 of FIG. 13) from mobility management devices in a network.

Hereinafter, for case of description, “mobility data of a UE” may be abbreviated to “mobility data.” The mobility data may be, for example, mobility data of the UE collected by the mobility management devices distributed within the network, such as AMF devices, and transmitted to the first data analysis device, but is not necessarily limited thereto.

The mobility data may include, for example, any one or a combination of location information on a location to which the UE has moved in an active mode in which the UE performs communication, a first elapsed time that the UE is in the active mode, and a second elapsed time that the UE is in an idle mode in which the UE does not perform communication, but is not necessarily limited thereto. The location information may include, any one or a combination of, identification information of the UE (e.g., an ID of the UE), information on a first base station corresponding to a first location (e.g., a source) from which the UE has departed in the active mode, and information on a second base station corresponding to a second location (e.g., a destination) at which the UE has arrived by moving from the first location in the active mode, but is not necessarily limited thereto.

Hereinafter, the “first elapsed time” may be a time elapsed by the UE in the active mode, and the “second elapsed time” may be a time elapsed by the UE in the idle mode.

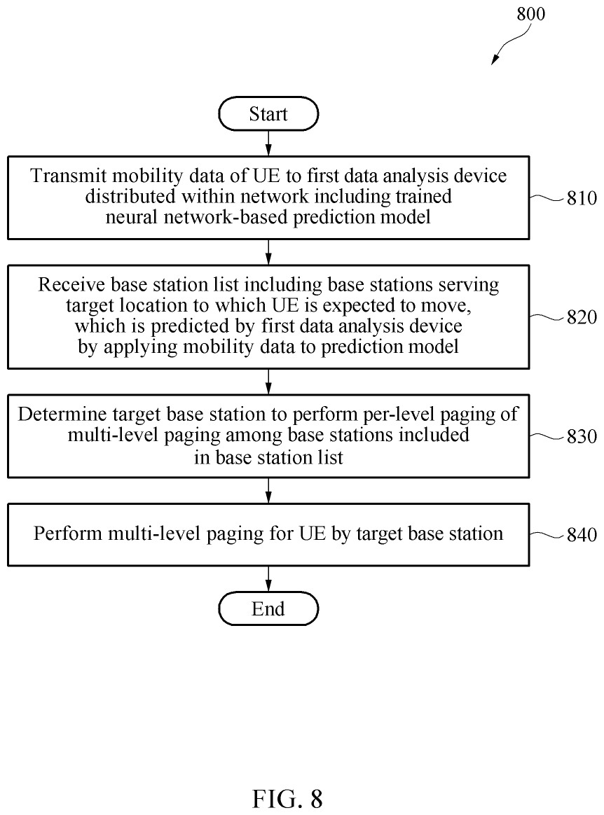

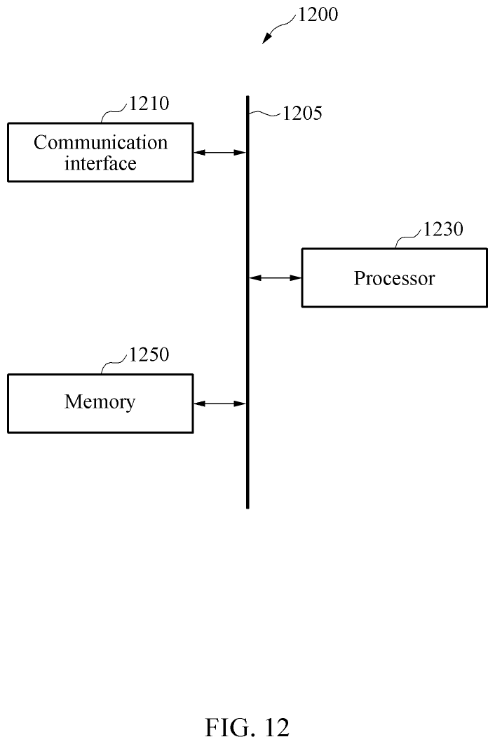

The mobility management devices (e.g., the AMF 130 of FIG. 1, the mobility management device 310 of FIG. 3, a mobility management device 805 of FIG. 8, mobility management devices 1005 and 1065 of FIG. 10, and/or a mobility management device 1200 of FIG. 12) may include, for example, an AMF device and/or a MME, but are not necessarily limited thereto. The mobility management devices may sample the mobility data of the UE at fixed intervals, such as, for example, 3 seconds, 5 seconds, or 10 seconds, and transmit the sampled mobility data to the first data analysis devices. The first data analysis devices may transmit mobility data collected from the mobility management device to the second data analysis device periodically or upon request from the second data analysis device.

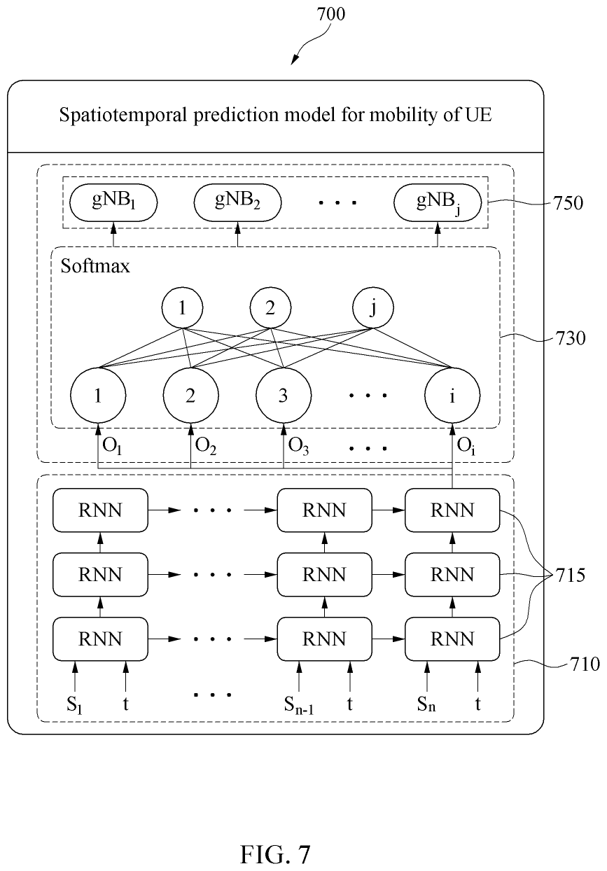

In operation 520, the second data analysis device may perform preprocessing on the mobility data collected in operation 510. Here, “preprocessing” may refer, for example, to a process of processing mobility data into a form (e.g., a batch form capable of batch processing) for use in training and evaluating a prediction model (e.g., a prediction model 700 of FIG. 7 and/or a prediction model 1050 of FIG. 10). The second data analysis device may, for example, divide the mobility data according to identification information of the UE to generate one continuous sequence. The second data analysis device may segment the one continuous sequence into a plurality of unit sequences including location information corresponding to fixed time units. The second data analysis device may configure the plurality of unit sequences into a batch for training and evaluating the prediction model based on a movement path of the UE during the first elapsed time that the UE is in the active mode and a target location of the UE during the second elapsed time that the UE is in the idle mode.

An example of a method by which the second data analysis device configures the plurality of unit sequences into a batch is described as follows.

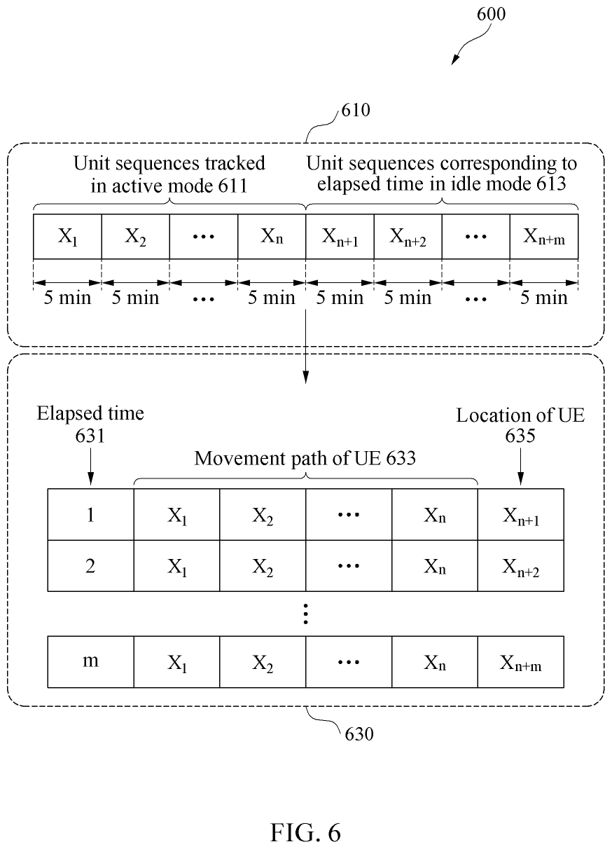

The second data analysis device may set first unit sequences of the plurality of unit sequences belonging to the first elapsed time as an input for training the prediction model. The second data analysis device may set second unit sequences of the plurality of unit sequences belonging to the second elapsed time as a label for evaluating the prediction model. The second data analysis device may configure information including, for example, but not necessarily limited to, identification information of the UE, a second elapsed time, a movement path of the UE during a first elapsed time, and a target location of the UE after the second elapsed time, into a batch. A method by which the second data analysis device preprocesses mobility data is described in more detail with reference to FIG. 6 below.

In operation 530, the second data analysis device may apply the mobility data preprocessed in operation 520 to a neural network-based prediction model to train the prediction model to predict base stations serving a target location to which the UE is expected to move. The second data analysis device may train the prediction model to predict the base stations serving the target location using mobility data sampled by the mobility management device over, for example, a fixed time interval and a first elapsed time that the UE is in the active mode.

The prediction model may be, for example, a spatiotemporal prediction model that predicts the base stations serving the target location to which the UE is expected to move at the time of paging when the UE transitions from the idle mode to the active mode, but is not necessarily limited thereto.

The prediction model may include, for example, a stacked deep neural network (e.g., a stacked recurrent neural network 710 of FIG. 7) and fully connected layers (e.g., fully connected layers 730), but is not necessarily limited thereto.

The stacked deep neural network may be input with the preprocessed mobility data to learn spatiotemporal features of the mobility of the UE. The stacked deep neural network may include, for example, an input layer including recurrent neural network cells, and hidden layers. As previous location paths over a fixed time interval of the UE and a second elapsed time that the UE is in the idle mode are applied to the input layer, the hidden layers may learn the target location to which the UE is expected to move in the second elapsed time based on the previous location paths.

For example, the fully connected layers may output a base station list (e.g., a base station list 750 of FIG. 7 and/or a base station list 1006 of FIG. 10) that includes probabilities that the UE is located at each base station from an output of the stacked deep neural network through a softmax activation function. In an embodiment, the softmax activation function is provided as an example for ease of description, but examples are not limited thereto, and various other activation functions may be used.

The data analysis device (e.g., the first data analysis devices or the second data analysis device) may align the probabilities that the UE is located at each base station output through the fully connected layers and output a base station list including base stations corresponding to a predetermined percentage of the aligned probabilities. The structure and operation of the prediction model are described in more detail below with reference to FIG. 7.

In operation 540, the second data analysis device may transfer the prediction model trained in operation 530 and the identification information of the UE to the first data analysis devices.

The process by which offline training and online prediction are performed in a network including the first data analysis devices, the second data analysis device, and the mobility management devices, according to an embodiment, is described in greater detail below with reference to FIG. 10.

FIG. 6 is a diagram illustrating an example process of preprocessing mobility data, according to various embodiments. Referring to FIG. 6, a diagram 600 of a plurality of unit sequences 610 generated by dividing one continuous sequence based on mobility data of a UE (e.g., the UE 110 of FIG. 1, the UEs 250 and 260 of FIG. 2, and/or the electronic device 1301 of FIG. 13) by fixed time units, and a batch 630 formed by the plurality of unit sequences 610 is illustrated.

As described above, a mobility management device (e.g., the AMF 130 of FIG. 1, the mobility management device 310 of FIG. 3, the mobility management device 805 of FIG. 8, the mobility management devices 1005 and 1065 of FIG. 10, and/or the mobility management device 1200 of FIG. 12) according to an embodiment, may record and collect mobility data including location information and/or time information that the UE has moved in an active mode to predict the mobility of the UE. The mobility data may also be referred to as “log” in that the mobility data includes location and time information that occurs in a network. The mobility data initially collected by the mobility management device may include, for example, identification information of the UE (UE ID), source gNB and destination gNB, and travel time.

The second data analysis device (e.g., the second data analysis device 1001 of FIG. 10) may divide the collected mobility data according to UE ID to generate one continuous sequence. The second data analysis device may segment the one continuous sequence into the plurality of unit sequences 610 including location information corresponding to a fixed time unit (e.g., 5 minutes).

The second data analysis device may divide the one continuous sequence (e.g., <i, X₁, X₂, . . . >) in which the mobility data is divided according to the UE ID into fixed time intervals to segment into the plurality of unit sequences 610 for spatiotemporal prediction. Here, i may represent the UE ID, and X₁, X₂, . . . may represent the location information of the UE corresponding to a fixed time unit.

The plurality of unit sequences 610 may include unit sequences 611 corresponding to a first elapsed time that the UE is tracked in an active mode and unit sequences 613 corresponding to a second elapsed time that the UE is in an idle mode.

For example, the fixed time interval may be 5 minutes, and the mobility data of the UE i may be given as 4-tuples such as (i,1,3,14:00), (i,3,5,14:15), and (i,5,4,14:20).

In this case, the second data analysis device may generate a 5-minute movement sequence (i,1,3,3,3,5,4) from the 4-tuples representing the mobility of the UE over a 20-minute period.

In an embodiment, the second data analysis device may sample the tuples at fixed intervals of 5 minutes to generate a movement sequence <c, l₁, l₂, . . . , > for spatiotemporal prediction, and may use the generated movement sequence <c, l₁, l₂, . . . , > to configure a batch for training and evaluating a prediction model (e.g., the prediction model 700 of FIG. 7 and/or the prediction model 1050 of FIG. 10). Here, c may be UE ID or identification information of a cluster to which the UE belongs, and l_{(.)} may represent identification information (gNB ID) of a base station serving a location of the UE in 5 minute units.

For example, the UE may move for 6 hours in the active mode and 4 hours in the idle mode, for a total of 10 hours of movement. In this case, the prediction model may be trained using a movement path tracked during 6 hours (the “first elapsed time”) in the active mode of the UE and a movement path during 4 hours (the “second elapsed time”) elapsed in the idle mode of the UE.

The second data analysis device may take one sequence corresponding to 10 hours and divide the one sequence into fixed time intervals (e.g., 5 minutes) to segment into (10 hours×60 minutes)/5 minutes=120 unit sequences. The second data analysis device may use (6 hours×60 minutes)/5 minutes=72 unit sequences corresponding to the 6 hours (the “first elapsed time”) tracked in the active mode among the 120 unit sequences as input for training the prediction model. In addition, the second data analysis device may use (4 hours×60 minutes)/5 minutes=48 unit sequences corresponding to the 4 hours (the “second elapsed time”) elapsed in the idle mode among the 120 unit sequences as labels for evaluating the prediction model.

The second data analysis device may configure the plurality of unit sequences into the batch 630 for training and evaluating the prediction model based on information including a movement path of the UE during the first elapsed time that the UE is in the active mode and a target location of the UE during the second elapsed time that the UE is in the idle mode.

The second data analysis device may configure the batch 630 with, for example, [a UE ID, an elapsed time (a second elapsed time) 631 in the idle mode, a movement path (e.g., X₁, X₂, . . . , X₇₂) 633 of the UE during the first elapsed time, a (target) location 635 of the UE after the second elapsed time] in order to perform learning and evaluation independently for each elapsed time. The second data analysis device may use normalized sequences of the same length for training and testing the prediction model. For example, the second data analysis device may convert the plurality of unit sequences 610, such as <i, X₁, X₂, . . . , X₁₂₀>, into the batch 630, such as, [i, 1, X₁, X₂, . . . , X₇₂, X₇₃], [i, 2, X₁, X₂, . . . , X₇₂, X₇₄], . . . , [i, 48, X₁, X₂, . . . , X₇₂, X₁₂₀], for use in learning and evaluation.

The second data analysis device may store the preprocessed mobility data, e.g., the batch 630, in a cloud server, or in a mobility dataset in a separate repository.

FIG. 7 is a diagram illustrating an example configuration and an example operation of a neural network-based prediction model, according to various embodiments. Referring to FIG. 7, a block diagram of a prediction model 700 (e.g., the prediction model 1050 of FIG. 10) according to various embodiments.

The prediction model 700 may be, for example, a machine learning model or a deep neural network (DNN)-based model.

The prediction model 700 may include a stacked DNN 710 for learning a sequential input and fully connected layers 730 for generating an output.

The stacked DNN 710 may receive preprocessed mobility data as an input to learn spatiotemporal features of the mobility of a UE (e.g., the UE 110 of FIG. 1, the UEs 250 and 260 of FIG. 2, and/or the electronic device 1301 of FIG. 13). Deep neural network (RNN) cells 715 included in the stacked DNN 710 may be an RNN-based AI model. The RNN cells 715 may represent a recurrent layer of the DNN, and an output of the cells may be referred to as a hidden state. The RNN cells 715 may be, for example, cells of a recurrent neural network (RNN), but are not necessarily limited thereto.

The stacked DNN 710 may be, for example, an RNN-based neural network, such as long short-term memory (LSTM) or gated recurrent units (GRU), but is not necessarily limited thereto. The stacked DNN 710 may be replaced by other AI models other than an RNN.

The stacked DNN 710 may include, for example, three layers of the RNN cells 715, but is not necessarily limited thereto. For ease of description, a stacked structure with three layers is shown in FIG. 7, but embodiments are not necessarily limited thereto. The prediction model 700 may be a multi-layer neural network with a depth greater than three layers.

A first layer of the stacked DNN 710 may be an input layer for receiving an input of a previous location path Sn of the UE and a second elapsed time t in an idle mode. The previous location path Sn of the UE input to each of the RNN cells in the input layer may represent previous location information at fixed time intervals, and may be input sequentially by the length of the input sequence from S₁ to Sₙ. Since the second elapsed time t is not time series data, the second elapsed time t may be equally input to all RNN cells such that the stacked DNN 710 is trained regardless of the order or location of the inputs.

A second and third layer of the stacked DNN 710 may operate as hidden layers that are not involved in the input and output. In this case, the number of layers and number of nodes used as hidden layers in the stacked DNN 710 may be experimentally and/or empirically set to a value appropriate for the application environment.

An output of the RNN cells is transferred to the next RNN cell in the same layer and to the RNN cells in the next layer, so that an output of the last RNN cell in the top layer may be a final output O of the stacked DNN 710.

An output layer 750 of the prediction model 700 may output a probability that the UE is located at each base station (gNB) using the fully connected layers 730. For example, the fully connected layers 730 may output a base station list that includes the probability that the UE is located at each base station from the output O of the stacked DNN 710 through activation functions such as a softmax activation function.

The fully connected layers 730 may receive i outputs O of the stacked DNN 710 and output j hidden state values, which is the number of base stations to be predicted. Here, i may be the same as or different from n, which is the number of input values of the stacked DNN 710. The softmax activation function may output a normalized value between 0 to 1, and the sum of the output values may always be 1. Thus, each of the output values of the prediction model 700 may represent a probability that the UE is located at the corresponding base station. Upon receiving from the first data analysis device a probability that the UE is located at the corresponding base station, e.g., a list of base stations (the “base station list”) serving a target location to which the UE is expected to move, the mobility management device may perform multi-level paging by selecting the predicted base station(s) as a paging target.

FIG. 8 is a flowchart illustrating an example method of operating a mobility management device, according to various embodiments. In the following embodiments, operations may be performed sequentially, but not necessarily performed sequentially. For example, the order of the operations may be changed and at least two of the operations may be performed in parallel.

Referring to flowchart 800 of FIG. 8, a mobility management device (e.g., the AMF 130 of FIG. 1, the mobility management device 310 of FIG. 3, the mobility management device 805 of FIG. 8, the mobility management devices 1005 and 1065 of FIG. 10, and/or the mobility management device 1200 of FIG. 12) according to an embodiment may perform multi-level paging for a UE (e.g., the UE 110 of FIG. 1, the UEs 250 and 260 of FIG. 2, and/or the electronic device 1301 of FIG. 13) through operations 810 to 840.

In operation 810, the mobility management device may transmit mobility data of the UE to a first data analysis device (e.g., the first data analysis devices 1003 and 1060 of FIG. 10) distributed within a network. The first data analysis device may include a neural network-based trained prediction model (e.g., the prediction model 700 of FIG. 7 and/or the prediction model 1050 of FIG. 10). The mobility data may include, for example, any one or a combination of, location information on a location to which the UE has moved in an active mode in which the UE performs communication, a first elapsed time that the UE is in the active mode, and a second elapsed time that the UE is in an idle mode in which the UE does not perform communication, but is not necessarily limited thereto.

In operation 820, the mobility management device may receive a base station list (e.g., the base station list 750 of FIG. 7 and/or the base station list 1006 of FIG. 10) including base stations serving a target location to which the UE is expected to move, which is predicted by the first data analysis device by applying mobility data to the prediction model.

In operation 830, the mobility management device may determine a target base station to perform per-level paging of the multi-level paging among the base stations included in the base station list received in operation 820. For example, when it is determined that the UE is not present in a cell of a last known base station in the active mode, the mobility management device may determine a target base station among the base stations included in the base station list, based on a paging service type corresponding to the UE.

Depending on the paging service type, the mobility management device may determine the target base station by adjusting a ratio of a first target base station used for level 1 paging and a second target base station used for level 2 paging among the base stations included in the base station list. More specifically, the mobility management device may determine which paging service type is a paging service type corresponding to the UE among a first service type (iPRS) for reduced signaling and a second service type (iPRD) for reduced delay. For example, the mobility management device may determine which paging service type is the paging service type corresponding to the UE based on at least one of a service type and a billing policy corresponding to the UE.

The mobility management device may adjust the ratio of the first target base station used for level 1 paging and the second target base station used for level 2 paging among the base stations according to the paging service type. For example, when the determined paging service type is the first service type, the mobility management device may determine the last known base station in which the UE is in the active mode to be the first target base station, and determine the base stations included in the base station list to be the second target base station. Alternatively, when the determined paging service type is the second service type, the mobility management device may determine a number of base stations equal to a first ratio among the base stations included in the base station list to be the first target base station. The mobility management device may determine a number of base stations equal to a second ratio of the remainder excluding the first ratio among the base stations included in the base station list to be the second target base station. The method of performing multi-level paging by adjusting the ratio of base stations according to the paging service type is described in more detail below with reference to FIG. 9.

In operation 840, the mobility management device may perform the multi-level paging for the UE by the target base station determined in operation 830. The mobility management device may perform the level 1 paging by the first target base station determined in operation 830, and perform the level 2 paging by the second target base station.

FIG. 9 is a diagram illustrating example multi-level paging methods, according to various embodiments. Referring to FIG. 9, a diagram 900 of paging areas according to a typical multi-level paging method 910 and multi-level paging methods 930 and 950 in accordance with paging service types according to an embodiment is illustrated.

The paging service types according to an embodiment may include, for example, a first service type (iPRS) for reduced signaling and a second service type (iPRD) for reduced delay. The multi-level paging method 930 may be in accordance with the first service type (iPRS) for reduced signaling, and the multi-level paging method 950 may be in accordance with the second service type (iPRD) for reduced delay. The first service type (iPRS) may correspond to an integration platform as a service (iPaaS) for reduced signaling, and the second service type (iPRD) may correspond to an iPaaS for reduced delay.

The iPaaS may be a cloud-based software package that creates new applications or connects existing services and applications together to coordinate data flows. The iPaaS may include routines that may interact with existing services using standard protocols and data formats. The iPaaS may filter data and act as a transportation hub for data transfer. For example, the iPaaS may request data from one service, convert the data received via the request to a different data format required by another service, and transfer the converted data.

In the typical multi-level paging method 910, when it is determined that a UE (e.g., the UE 110 of FIG. 1, the UEs 250 and 260 of FIG. 2, and/or the electronic device 1301 of FIG. 13) is not present in a cell of one last known base station (e.g., the base station 330 of FIG. 3) in level 1 paging, paging messages are transmitted to base stations (e.g., the 5G RAN of FIG. 1, the base stations 215, 225, 235, and 245 of FIG. 2, and/or the base station 330 of FIG. 3) by gradually increasing the paging area to 64 cells in level 2 paging and 4096 cells in level 3 paging, and a large number of paging signals are sent to reduce a paging failure rate.

In an embodiment, a DNN-based prediction model (e.g., the prediction model 700 of FIG. 7 and/or the prediction model 1050 of FIG. 10) may be used to predict a number of base stations equal to 20% of the number of base stations in a TA of the typical multi-level paging method 910 to be base station(s) to perform paging, and the predicted base station(s) may be used for the first service type (iPRS) and second service type (iPRD) to increase a paging success rate while reducing signaling costs. A base station list (e.g., the base station list 750 of FIG. 7 and/or the base station list 1006 of FIG. 10) predicted by the prediction model may include base stations serving a target location to which the UE is expected to move.

For example, when the paging service type of the UE is the first service type (iPRS), the mobility management device may perform paging using the last known base station in level 1 paging, in the same manner as the typical multi-level paging method 910. In addition, the mobility management device may transmit paging messages to base stations corresponding to an area that is 20% the size of the TA used by the typical multi-level paging method 910 in level 2 paging.

The mobility management device may use the base station list in place of the TA to transmit page messages in the level 2 paging when the paging service type corresponding to the UE is the first service type (iPRS). In accordance with the first service type (iPRS), signaling costs may be significantly reduced by transmitting paging messages to 80% fewer base stations in the level 2 paging compared to the typical multi-level paging method 910, and by increasing the paging success rate using predicted base stations to perform paging.

Until recently, paging cost was the primary consideration in terms of signaling, but for URLLC services in 5G mobile networks, paging latency may be more important to a user experience.

For example, when the paging service type of the UE is the second service type (iPRD), the mobility management device may perform the level 1 paging using base stations serving a cell of the last known base station from a previous paging, along with areas served by the base stations included in the base station list predicted by the prediction model, in other words, base stations corresponding to 8% of base stations serving an area that is 20% the size of the TA used in the typical multi-level paging method 910. In addition, the mobility management device may perform the level 2 paging using base stations corresponding to 12% of the remainder excluding the previously used 8% among the base stations serving the area that is 20% the size of the TA used in the typical multi-level paging method 910.

When the paging service type is the second service type (iPRD), latency reduction is greater compared to the first service type (iPRS) because the increased number of base stations in the level 1 paging increases the paging success rate, but the total number of paging signaling may increase compared to the first service type (iPRS) because the number of paging signaling required in the level 1 paging increases.

In paging, the number of signaling and latency may be a tradeoff, so the mobility management device may use a paging service type that is appropriate for the user according to a service or billing policy.

For example, the mobility management device may determine which paging service type is the paging service type corresponding to the UE based on at least one of a service type and a billing policy corresponding to the UE.

In an embodiment, the mobility management device may perform the level 1 paging and level 2 paging by varying a ratio of base stations used by each of the first service type (iPRS) and second service type (iPRD).

A total signaling (TS) of the multi-level paging may be obtained by a sum of the number of signals required for each paging level, for example, as shown in Equation 1 below.

$$[ Equation 1 ]$$

$$TS = {S}_{1} \times {N}_{1} + ( 1 - {S}_{1} ) \times \vert {S}_{2} \times {N}_{2} + ( 1 - {S}_{1} ) \times ( 1 - {S}_{2} ) \times {S}_{3} \times {N}_{3} . \qquad ( 1 )$$

Here, Ni denotes a paging signal generated in paging level i, which may be obtained by substituting the number of target base stations used in the paging level i according to a paging service type that is selected. In addition, S denotes a paging success rate in paging level i.

Similarly, a total delay (TD) may be obtained by adding a latency incurred in each paging level i. For example, in the case of a successful paging, the TD may be a time (Tresp) required to receive a page response from the UE, and in the case of a failed paging, the TD may be T3513ᵢ, which is an expiry time of a paging timer (e.g., T3513) in the paging level i. For example, the TD may be calculated as shown in Equation 2 below.

$$[ Equation 2 ]$$

$$TD = {S}_{1} \times {T}_{resp} + ( 1 - {S}_{1} ) \times \vert {S}_{2} \times ( {T}_{resp} + T {3513}_{1} ) + ( 1 - {S}_{1} ) \times ( 1 - {S}_{2} ) \times {S}_{3} \times ( {T}_{resp} + {\sum }_{i ∈ 1 , 2} T {3513}_{i} ) . \qquad ( 2 )$$

FIG. 10 is a diagram illustrating an example operation of an offline training process and an online prediction process between a data analysis device and a mobility management device, according to various embodiments.

Recent 5G specifications of the third-generation partnership project (3GPP) may further include NWDAF to facilitate artificial intelligence (AI)-based optimization of network functions such as paging.

A data analysis device, including the second data analysis device 1001 and the first data analysis device 1003, according to an embodiment, may be a device configured to perform network data analysis functions.

Referring to FIG. 10, a structure 1000 of an iPaaS performing an offline training process 1007 of a prediction model 1050 (e.g., the prediction model 700 of FIG. 7) and an online prediction process 1009 using a base station list 1006 (e.g., the base station list 750 of FIG. 7) predicted by the trained prediction model 1050 is illustrated.

For example, an iPaaS according to an embodiment may extend a centralized structure to distributed NWDAF instances using serverless computing.

In the offline training process 1007, for example, data collection, clustering, and/or training of a prediction model may be performed, and significant computational resources may be used. Since the offline training process 1007 may be performed at a predetermined time, management of idle resources on standby may be required. Serverless computing may reduce the occurrence of idle resources since resources may be allocated based on requests from a computing device, such as a data analysis device (e.g., the data analysis device 1100 of FIG. 11), while the serverless computing is functioning. In an embodiment, offline training may be deployed as a service on a cloud server (or the second data analysis device 1001) using serverless computing to efficiently manage resources.

The online prediction process 1009 may use less computational resources than the offline training process 1007, but may be performed more frequently. The online prediction process 1009 may transmit a prediction result to the mobility management devices 1065 (e.g., the AMF 130 of FIG. 1, the mobility management device 310 of FIG. 3, the mobility management device 805 of FIG. 8, and/or the mobility management device 1200 of FIG. 12) in real time due to a high transmission time between the 5G core network and the cloud server (or the second data analysis device 1001).

The iPaaS may transmit the trained prediction model 1050 to the first data analysis devices 1060 distributed within the network to increase the response time of the real-time predictions and facilitate load balancing. As a result, an iPaaS structure may efficiently manage resources by eliminating idle resources and distributing load among the data analysis devices.

The offline training process 1007 may be performed using a serverless computing structure and a cloud server by one second data analysis device 1001 and the first data analysis devices 1003 distributed within the network. The one second data analysis device 1001 may be, for example, a cloud server or a separate device that performs NWDAF functions. In addition, the online prediction process 1009 may be performed by the mobility management devices 1065 using the base station list 1006 predicted by the trained prediction model 1050 and stored in the distributed first data analysis devices 1060. Here, the distributed first data analysis devices 1060 may be the same devices as the first data analysis devices 1003, and may store the trained prediction model 1050.

The first data analysis devices 1003 may collect historical mobility data of the UE(s) in active mode via the mobility management devices 1005 to determine a location of the UE(s). In terms of structure, the data analysis devices may be directly connected to any 5G core network to collect data and transmit analyzed results. In this case, when one logically centralized data analysis device is used, communication latency with the 5G core network may be increased, which may degrade the performance of all AI-based services. In addition, DNN and data analysis models require high computational resources, and data analysis devices host multiple AI models for different network functions instead of just one AI model, which may consume a lot of computational resources. For example, current cloud-native network function (CNF) implementations in 5G core networks continue to allocate resources even when the UE(s) are in an idle state, which may waste the resources of large data analysis devices.

In an embodiment, a serverless computing paradigm may be applied to a data analysis device and a location-based distributed NWDAF structure may be used to prevent and/or reduce idle resources from occurring and to balance load.

In the offline training process 1007, operations 1010 to 1040 may be performed, and in the online prediction process 1009, operation 1070 may be performed.

In operation 1010, the mobility management device 1005, such as the AMF device, may transmit mobility data sampling the movement path of the UE(s) at fixed intervals to the first data analysis devices 1003 distributed based on location.

In operation 1020, each of the distributed first data analysis devices 1003 may periodically transmit the mobility data to a data collection function of the second data analysis device 1001 (or cloud server) to reduce computational load. In an embodiment, the second data analysis device 1001 (or cloud server) may, for example, group the UE(s) into clusters based on time and mobility patterns, to ensure differentiated services for each cluster.

In operation 1030, the second data analysis device 1001 (or cloud server) may preprocess the mobility data and perform offline training of the prediction model 1050 based on the preprocessed mobility data. The offline training of the prediction model 1050 may be performed according to an input of two or more of, or a combination of, for example, a movement path S, an elapsed time (a “second elapsed time”) t of the UE in idle mode, and/or identification information (or identification information of a cluster to which the UE belongs) c of the UE.

The prediction model 1050 may include, for example, stacked GRUs and fully connected layers that output the base station list 1006 including a probability that the UE is located at each base station from the stacked GRUs through a softmax activation function.

The stacked GRUs may belong to a class of recurrent models for time series data and may have similar performance while requiring less computational space than LSTMs. The stacked GRUs may include three layers of n GRU cells each. A first layer of the stacked GRUs may be input with a previous movement path S of the UE and a second elapsed time t of the UE in idle mode, or a previous movement path S of the UE, a second elapsed time t of the UE in idle mode, and identification information c of a cluster to which the UE belongs.

Here, the second elapsed time t and the identification information c of the cluster are not time series data, so the same values may be provided to all cells in the input layer to train the prediction model 1050 regardless of order. A second layer and a third layer of the stacked GRUs may act as hidden layers and contribute to learning a basic mobility pattern of an input sequence. An output of GRU cells may be transmitted to a next cell in the same layer and all the following layers, starting from a first cell in the input layer. Such a sequential operation may continue until the last GRU cell of the top layer, where a result of the operation may be the final output of the stacked GRU.

In addition, an output layer of the prediction model 1050 may output a probability that the UE is located at each base station through the fully connected layers. The fully connected layers may receive the output of the stacked GRUs and use the softmax activation function to output the probability that the UE is present at each of j base stations. Here, the sum of all probabilities that the UE is present may always be 1.

The one second data analysis device 1001 or the first data analysis devices 1003 distributed within the network may generate a base station list by aligning, for example, in descending order, the probability that the UE is located at each base station output through the fully connected layers, and selecting base stations corresponding to a predetermined percentage (e.g., top 20%) of the aligned probabilities. The top 20% may be determined through experimentation to balance prediction accuracy with signaling overhead, but is not necessarily limited thereto.

In operation 1040, the second data analysis device 1001 (or cloud server) may propagate the trained prediction model 1050, along with the identification information of the UE (or the identification information of the cluster to which the UE belongs), to the distributed first data analysis devices 1060 to perform the online prediction process 1009.

In operation 1070 of the online prediction process 1009, the distributed first data analysis devices 1060 may transfer the base station list 1006 predicted by the prediction model 1050 to the mobility management devices 1065. The mobility management devices 1065 may perform multi-level paging using base stations included in the base station list 1006 according to the paging service type of the UE.

FIG. 11 is a block diagram illustrating an example configuration of a data analysis device, according to various embodiments. Referring to FIG. 11, a data analysis device 1100 according to an embodiment may include first data analysis devices (e.g., the first data analysis devices 1003 and 1060 of FIG. 10) distributed within a network and one centralized second data analysis device (e.g., the second data analysis device 1001 of FIG. 10).

The data analysis device 1100 may implement operations of the first data analysis devices distributed within the network and the centralized second data analysis device by a single cloud server, or by separate and distinct data analysis devices.

The data analysis device 1100 may include a communication interface (e.g., including communication circuitry) 1110, a processor (e.g., including processing circuitry) 1130, and a memory 1150. The communication interface 1110, the processor 1130, and the memory 1150 may be connected to each other via a communication bus 1105.

The communication interface 1110 may include various communication circuitry and collect mobility data of a UE (e.g., the UE 110 of FIG. 1, the UEs 250 and 260 of FIG. 2, and/or the electronic device 1301 of FIG. 13) from mobility management devices (e.g., the AMF 130 of FIG. 1, the mobility management device 310 of FIG. 3, the mobility management device 805 of FIG. 8, the mobility management devices 1005 and 1065 of FIG. 10, and/or the mobility management device 1200 of FIG. 12) within the network. The communication interface 1110 may transfer a base station list (e.g., the base station list 750 of FIG. 7 and/or the base station list 1006 of FIG. 10) predicted by a trained prediction model (e.g., the prediction model 700 of FIG. 7 and/or the prediction model 1050 of FIG. 10) and identification information of the UE to the mobility management device.

The processor 1130 may include various processing circuitry and preprocess the mobility data collected via the communication interface 1110 and apply the preprocessed mobility data to a neural network-based prediction model stored in the memory 1150 to train the prediction model to predict base stations serving a target location to which the UE is expected to move. The processor 1130 may also transfer the base station list predicted by the trained prediction model and the identification information of the UE to the mobility management device via the communication interface 1110.

The memory 1150 may store the neural network-based prediction model.

In addition, the processor 1130 can execute a program and control the data analysis device 1100. Program code to be executed by the processor 1130 may be stored in the memory 1150.

The memory 1150 may store information received from the communication interface 1110. The memory 1150 may store executable instructions to be executed by the processor 1130. In addition, the memory 1150 may store a variety of information generated during the processing of the processor 1130. The memory 1150 may also store a variety of data and programs. The memory 1150 may include a volatile memory or a non-volatile memory. The memory 1150 may include a high-capacity storage medium such as a hard disk to store a variety of data.

In addition, the processor 1130 may perform at least one method described with reference to FIGS. 1 to 10 or a scheme corresponding to the at least one method. The processor 1130 may be a hardware-implemented device or server having a physically structured circuit to execute desired operations. The desired operations may include, for example, code or instructions included in a program. The hardware-implemented data analysis device 1100 may include, for example, a microprocessor, a central processing unit (CPU), a graphics processing unit (GPU), a processor core, a multi-core processor, a multiprocessor, an ASIC, a field programmable gate array (FPGA), and/or a neural processing unit (NPU). The processor 1130 may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions.

FIG. 12 is a block diagram illustrating an example configuration of a mobility management device, according to various embodiments. Referring to FIG. 12, a mobility management device 1200 (e.g., the AMF 130 of FIG. 1, the mobility management device 310 of FIG. 3, the mobility management device 805 of FIG. 8, and/or the mobility management devices 1005 and 1065 of FIG. 10) according to an embodiment may include a communication interface 1210, a processor 1230, and a memory 1250. The communication interface 1210, the processor 1230, and the memory 1250 may be connected to each other via a communication bus 1205.

The communication interface 1210 may include various communication circuitry and transmit mobility data of a UE (e.g., the UE 110 of FIG. 1, the UEs 250 and 260 of FIG. 2, and/or the electronic device 1301 of FIG. 13) to a first data analysis device (e.g., the first data analysis devices 1003 and 1060 of FIG. 10) distributed within a network. The first data analysis device may include a neural network-based trained prediction model (e.g., the prediction model 700 of FIG. 7 and/or the prediction model 1050 of FIG. 10). The communication interface 1210 may receive a base station list (e.g., the base station list 750 of FIG. 7 and/or the base station list 1006 of FIG. 10) including base stations serving a target location to which the UE is expected to move, which is predicted by the prediction model by the first data analysis device based on mobility data.

The processor 1230 may include various processing circuitry and determine a target base station to perform per-level paging in multi-level paging among base stations (e.g., the 5G RAN of FIG. 1, the base stations 215, 225, 235, and 245 of FIG. 2, and/or the base station 330 of FIG. 3). The processor 1230 may perform multi-level paging for the UE by the target base station.

In addition, the processor 1230 may execute a program and control the mobility management device 1200. Program code to be executed by the processor 1230 may be stored in the memory 1250.

The memory 1250 may store information received from the communication interface 1210. The memory 1250 may store executable instructions to be executed by the processor 1230. In addition, the memory 1250 may store a variety of information generated during the processing of the processor 1230. The memory 1250 may also store a variety of data and programs. The memory 1250 may include a volatile memory or a non-volatile memory. The memory 1250 may include a high-capacity storage medium such as a hard disk to store a variety of data.

In addition, the processor 1230 may perform at least one method described with reference to FIGS. 1 to 10 or a scheme corresponding to the at least one method. The processor 1230 may be a hardware-implemented communication device having a physically structured circuit to execute desired operations. The desired operations may include, for example, code or instructions included in a program. For example, the hardware-implemented mobility management device 1200 may include a microprocessor, a CPU, a GPU, a processor core, a multi-core processor, a multiprocessor, an ASIC, a FPGA, and/or a NPU. The processor 1230 may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions.

FIG. 13 is a block diagram illustrating an example electronic device 1301 in the network environment 1300 according to various embodiments. Referring to FIG. 13, the electronic device 1301, which is an example of a UE (e.g., the UE 110 of FIG. 1, the UEs 250 and 260 of FIG. 2, and/or the electronic device 1301 of FIG. 13) in the network environment 1300, may communicate with an electronic device 1302 via a first network 1398 (e.g., a short-range wireless communication network), or communicate with at least one of an electronic device 1304 or the server 1308 via a second network 1399 (e.g., a long-range wireless communication network). In an embodiment, the electronic device 1301 may communicate with the electronic device 1304 via the server 1308. According to an embodiment, the electronic device 1301 may include a processor 1320, a memory 1330, an input module 1350, a sound output module 1355, a display module 1360, an audio module 1370, a sensor module 1376, an interface 1377, a connecting terminal 1378, a haptic module 1379, a camera module 1380, a power management module 1388, a battery 1389, a communication module 1390, a subscriber identification module (SIM) 1396, or an antenna module 1397. In an embodiment, at least one of the components (e.g., the connecting terminal 1378) may be omitted from the electronic device 1301, or one or more other components may be added in the electronic device 1301. In various embodiments, some of the components (e.g., the sensor module 1376, the camera module 1380, or the antenna module 1397) may be integrated as a single component (e.g., the display module 1360).

The processor 1320 may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions. The processor 1320 may execute, for example, software (e.g., a program 1340) to control at least one other component (e.g., a hardware or software component) of the electronic device 1301 connected to the processor 1320 and may perform various data processing or computation. According to an embodiment, as at least a part of data processing or computation, the processor 1320 may store a command or data received from another component (e.g., the sensor module 1376 or the communication module 1390) in a volatile memory 1332, process the command or the data stored in the volatile memory 1332, and store resulting data in a non-volatile memory 1334. According to an embodiment, the processor 1320 may include a main processor 1321 (e.g., a CPU or an application processor (AP)), or an auxiliary processor 1323 (e.g., a GPU, an NPU, an image signal processor (ISP), a sensor hub processor, or a communication processor (CP)) that is operable independently from, or in conjunction with the main processor 1321. For example, when the electronic device 1301 includes the main processor 1321 and the auxiliary processor 1323, the auxiliary processor 1323 may be adapted to consume less power than the main processor 1321 or to be specific to a specified function. The auxiliary processor 1323 may be implemented separately from the main processor 1321 or as a part of the main processor 1321.

The auxiliary processor 1323 may control at least some of functions or states related to at least one (e.g., the display module 1360, the sensor module 1376, or the communication module 1390) of the components of the electronic device 1301, instead of the main processor 1321 while the main processor 1321 is in an inactive (e.g., sleep) state or along with the main processor 1321 while the main processor 1321 is in an active state (e.g., executing an application). According to an embodiment, the auxiliary processor 1323 (e.g., an ISP or a CP) may be implemented as a portion of another component (e.g., the camera module 1380 or the communication module 1390) that is functionally related to the auxiliary processor 1323. According to an embodiment, the auxiliary processor 1323 (e.g., an NPU) may include a hardware structure specified for AI model processing. An AI model may be generated by machine learning. Such learning may be performed by, for example, the electronic device 1301 in which an AI model is executed, or performed via a separate server (e.g., the server 1308). Learning algorithms may include, but are not limited to, for example, supervised learning, unsupervised learning, semi-supervised learning, or reinforcement learning. The AI model may include a plurality of artificial neural network layers. An artificial neural network may include, for example, a DNN, a convolutional neural network (CNN), an RNN, a restricted Boltzmann machine (RBM), a deep belief network (DBN), and a bidirectional recurrent deep neural network (BRDNN), a deep Q-network, or a combination of two or more thereof, but is not limited thereto. The AI model may additionally or alternatively include a software structure other than the hardware structure.

The memory 1330 may store various pieces of data used by at least one component (e.g., the processor 1320 or the sensor module 1376) of the electronic device 1301. The various pieces of data may include, for example, software (e.g., the program 1340) and input data or output data for a command related thereto. The memory 1330 may include the volatile memory 1332 or the non-volatile memory 1334.

The program 1340 may be stored as software in the memory 1330 and may include, for example, an operating system (OS) 1342, middleware 1344, or an application 1346.

The input module 1350 may receive a command or data to be used by another component (e.g., the processor 1320) of the electronic device 1301, from the outside (e.g., a user) of the electronic device 1301. The input module 1350 may include, for example, a microphone, a mouse, a keyboard, a key (e.g., a button), or a digital pen (e.g., a stylus pen).

The sound output module 1355 may output a sound signal to the outside of the electronic device 1301. The sound output module 1355 may include, for example, a speaker or a receiver. The speaker may be used for general purposes, such as playing multimedia or playing a record. The receiver may be used to receive an incoming call. According to an embodiment, the receiver may be implemented separately from the speaker or as a part of the speaker.

The display module 1360 may visually provide information to the outside (e.g., a user) of the electronic device 1301. The display module 1360 may include, for example, a display, a hologram device, or a projector and control circuitry to control a corresponding one of the display, hologram device, and projector. According to an embodiment, the display module 1360 may include a touch sensor adapted to detect a touch, or a pressure sensor adapted to measure the intensity of force incurred by the touch.

The audio module 1370 may convert a sound into an electrical signal or vice versa. According to an embodiment, the audio module 1370 may obtain the sound via the input module 1350 or output the sound via the sound output module 1355 or an external electronic device (e.g., the electronic device 1302 such as a speaker or headphones) directly or wirelessly connected to the electronic device 1301.

The sensor module 1376 may detect an operational state (e.g., power or temperature) of the electronic device 1301 or an environmental state (e.g., a state of a user) external to the electronic device 1301, and generate an electric signal or data value corresponding to the detected state. According to an embodiment, the sensor module 1376 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 1377 may support one or more specified protocols to be used for the electronic device 1301 to be coupled with the external electronic device (e.g., the electronic device 1302) directly (e.g., by wire) or wirelessly. According to an embodiment, the interface 1377 may include, for example, a high-definition multimedia interface (HDMI), a universal serial bus (USB) interface, a secure digital (SD) card interface, or an audio interface.

The connecting terminal 1378 may include a connector via which the electronic device 1301 may be physically connected to the external electronic device (e.g., the electronic device 1302). According to an embodiment, the connecting terminal 1378 may include, for example, an HDMI connector, a USB connector, an SD card connector, or an audio connector (e.g., a headphone connector).

The haptic module 1379 may convert an electrical signal into a mechanical stimulus (e.g., a vibration or a movement) or an electrical stimulus which may be recognized by a user via his or her tactile sensation or kinesthetic sensation. According to an embodiment, the haptic module 1379 may include, for example, a motor, a piezoelectric element, or an electric stimulator.

The camera module 1380 may capture a still image and moving images. According to an embodiment, the camera module 1380 may include one or more lenses, image sensors, image signal processors, or flashes.

The power management module 1388 may manage power supplied to the electronic device 1301. According to an embodiment, the power management module 1388 may be implemented as, for example, at least a part of a power management integrated circuit (PMIC).

The battery 1389 may supply power to at least one component of the electronic device 1301. According to an embodiment, the battery 1389 may include, for example, a primary cell which is not rechargeable, a secondary cell which is rechargeable, or a fuel cell.

The communication module 1390 may support establishing a direct (e.g., wired) communication channel or a wireless communication channel between the electronic device 1301 and the external electronic device (e.g., the electronic device 1302, the electronic device 1304, or the server 1308) and performing communication via the established communication channel. The communication module 1390 may include one or more CPs that are operable independently of the processor 1320 (e.g., an application processor) and that support a direct (e.g., wired) communication or a wireless communication. According to an embodiment, the communication module 1390 may include a wireless communication module 1392 (e.g., a cellular communication module, a short-range wireless communication module, or a global navigation satellite system (GNSS) communication module) or a wired communication module 1394 (e.g., a local area network (LAN) communication module, or a power line communication (PLC) module). A corresponding one of these communication modules may communicate with the external electronic device 1304 via the first network 1398 (e.g., a short-range communication network, such as Bluetooth™, wireless-fidelity (Wi-Fi) direct, or infrared data association (IrDA)) or the second network 1399 (e.g., a long-range communication network, such as a legacy cellular network, a 5G network, a next-generation communication network, the Internet, or a computer network (e.g., a LAN or a wide area network (WAN))). These various types of communication modules may be implemented as a single component (e.g., a single chip) or may be implemented as multiple components (e.g., multiple chips) separate from each other. The wireless communication module 1392 may identify or authenticate the electronic device 1301 in a communication network, such as the first network 1398 or the second network 1399, using subscriber information (e.g., international mobile subscriber identity (IMSI)) stored in the SIM 1396.

The wireless communication module 1392 may support a 5G network after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 1392 may support a high-frequency band (e.g., a mmWave band) to achieve, e.g., a high data transmission rate. The wireless communication module 1392 may support various technologies for securing performance on a high-frequency band, such as, e.g., beamforming, massive multiple-input and multiple-output (massive MIMO), full dimensional MIMO (FD-MIMO), an array antenna, analog beam-forming, or a large scale antenna. The wireless communication module 1392 may support various requirements specified in the electronic device 1301, an external electronic device (e.g., the electronic device 1304), or a network system (e.g., the second network 1399). According to an embodiment, the wireless communication module 1392 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 1397 may transmit or receive a signal or power to or from the outside (e.g., the external electronic device) of the electronic device 1301. According to an embodiment, the antenna module 1397 may include an antenna including a radiating element including a conductive material or a conductive pattern formed in or on a substrate (e.g., a printed circuit board (PCB)). According to an embodiment, the antenna module 1397 may include a plurality of antennas (e.g., array antennas). In such a case, at least one antenna appropriate for a communication scheme used in a communication network, such as the first network 1398 or the second network 1399, may be selected by, for example, the communication module 1390 from the plurality of antennas. The signal or the power may be transmitted or received between the communication module 1390 and the external electronic device via the at least one selected antenna. According to an embodiment, another component (e.g., a radio frequency integrated circuit (RFIC)) other than the radiating element may be additionally formed as a part of the antenna module 1397.

According to an embodiment, the antenna module 1397 may form a mmWave antenna module. According to an embodiment, the mmWave antenna module may include a PCB, an RFIC disposed on a first surface (e.g., the bottom surface) of the PCB or adjacent to the first surface and capable of supporting a designated high-frequency band (e.g., a mmWave band), and a plurality of antennas (e.g., array antennas) disposed on a second surface (e.g., the top or a side surface) of the PCB, or adjacent to the second surface and capable of transmitting or receiving signals in the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 1301 and the external electronic device 1304 via the server 1308 coupled with the second network 1399. Each of the external electronic devices 1302 or 1304 may be a device of the same type as or a different type from the electronic device 1301. According to an embodiment, all or some of operations to be executed by the electronic device 1301 may be executed at one or more of the external electronic devices 1302 and 1304, and the server 1308. For example, if the electronic device 1301 needs to perform a function or a service automatically, or in response to a request from a user or another device, the electronic device 1301, instead of, or in addition to, executing the function or the service, may request one or more external electronic devices to perform at least part of the function or the service. The one or more external electronic devices receiving the request may perform the at least part of the function or the service requested, or an additional function or an additional service related to the request, and may transfer an outcome of the performing to the electronic device 1301. The electronic device 1301 may provide the outcome, with or without further processing of the outcome, as at least part of a reply to the request. To that end, cloud computing, distributed computing, mobile edge computing (MEC), or client-server computing technology may be used, for example. The electronic device 1301 may provide ultra low-latency services using, e.g., distributed computing or mobile edge computing. In an embodiment, the external electronic device 1304 may include an Internet-of-things (IoT) device. The server 1308 may be an intelligent server using machine learning and/or a neural network. According to an embodiment, the external electronic device 1304 or the server 1308 may be included in the second network 1399. The electronic device 1301 may be applied to intelligent services (e.g., smart home, smart city, smart car, or healthcare) based on 5G communication technology or IoT-related technology.

According to an example embodiment, a method for operating a data analysis device including first data analysis devices distributed within a network and a centralized second data analysis device may include: collecting mobility data of a user equipment (UE) from mobility management devices in the network, a second data analysis device preprocessing the mobility data, the second data analysis device applying the preprocessed mobility data to a neural network-based prediction model to train the prediction model to predict base stations serving a target location to which the UE is expected to move, and transferring the trained prediction model and identification information of the UE to the first data analysis devices.

According to an example embodiment, the mobility data may include, any one or a combination of, location information on a location to which the UE has moved in an active mode in which the UE performs communication, a first elapsed time that the UE is in the active mode, and a second elapsed time that the UE 110 is in an idle mode in which the UE does not perform the communication.

According to an example embodiment, the location information may include, any one or a combination of, identification information of the, information on a first base station corresponding to a first location from which the UE has departed in the active mode, and information on a second base station corresponding to a second location at which the UE has arrived by moving from the first location in the active mode.

According to an example embodiment, the preprocessing of the mobility data may include: dividing the mobility data according to the identification information of the UE to generate a continuous sequence, segmenting the continuous sequence into a plurality of unit sequences including location information corresponding to fixed time units, and configuring the plurality of unit sequences into a batch for training and evaluating the prediction model, based on a movement path of the UE during the first elapsed time that the UE is in the active mode and a target location of the UE during the second elapsed time that the UE is in the idle mode.

According to an example embodiment, the configuring of the plurality of unit sequences into the batch may include setting first unit sequences of the plurality of unit sequences belonging to the first elapsed time as an input for training the prediction model, setting second unit sequences of the plurality of unit sequences belonging to the second elapsed time as a label for evaluating the prediction model, and configuring information including the identification information of the UE, the second elapsed time, the movement path of the UE during the first elapsed time, and the target location of the UE after the second elapsed time into the batch.

According to an example embodiment, the training may include training the prediction model to predict the base stations serving the target location using mobility data sampled over a fixed time interval and the first elapsed time that the UE is in the active mode.

According to an example embodiment, the prediction model may include a stacked DNN configured to receive the preprocessed mobility data as input and learn spatiotemporal features of mobility of the UE, and fully connected layers configured to output a base station list including a probability that the UE is at each base station from an output of the stacked DNN.

According to an example embodiment, the stacked DNN may include an input layer including DNN cells, and hidden layers, and as previous location paths over the fixed time interval of the UE, and the second elapsed time that the UE is in the idle mode are applied to the input layer, the hidden layers may learn the target location to which the UE is expected to move in the second elapsed time based on the previous location paths.

According to an example embodiment, the data analysis device may align the probability that the UE is located at each base station output through the fully connected layers, and output the base station list including base stations corresponding to a specified percentage of the aligned probabilities.

According to an example embodiment, a method for operating a mobility management device 130 may include th transmitting mobility data of the UE to a first data analysis device distributed within a network, the first data analysis device including a neural network-based trained prediction model, receiving a base station list including base stations serving a target location to which the UE 110 is expected to move, predicted by the first data analysis device by applying the mobility data to the prediction model, determining a target base station to perform per-level paging of multi-level paging among the base stations included in the base station list, and performing the multi-level paging for the UE by the target base station.

According to an example embodiment, the determining of the target base station may include, in response to it being determined that the UE is not present in a cell of a last known base station in the active mode, determining the target base station among the base stations included in the base station list according to a paging service type corresponding to the UE.

According to an example embodiment, the determining of the target base station may include determining which paging service type is a paging service type corresponding to the UE among a first service type (iPRS) for reduced signaling and a second service type (iPRD) for reduced delay, and adjusting a ratio of a first target base station used for level 1 paging and a second target base station used for level 2 paging among the base stations, according to the determined paging service type.

According to an example embodiment, the determining of which paging service type may include determining which of the paging service types is the paging service type corresponding to the UE based on at least one of a service type and a billing policy corresponding to the UE.

According to an example embodiment, the adjusting of the ratio of the first target base station and the second target base station may include, in response to the determined paging service type being the first service type, determining the last known base station where the UE is in the active mode to be the first target base station, and determining the base stations included in the base station list to be the second target base station.

According to an example embodiment, the adjusting of the ratio of the first target base station and the second target base station may include, in response to the determined paging service type being the second service type, determining a number of base stations equal to a first ratio of the base stations included in the base station list to be the first target base station, and determining a number of base stations equal to a second ratio of the remainder excluding the first ratio of the base stations included in the base station list to be the second target base station.

According to an example embodiment, the performing of the multi-level paging may include performing level 1 paging by the first target base station, and performing level 2 paging by the second target base station.

According to an example embodiment, the mobility data may include, any one or a combination of, location information on a location to which the UE has moved in an active mode in which the UE performs communication, a first elapsed time that the UE is in the active mode, and a second elapsed time that the UE is in an idle mode in which the UE does not perform the communication.

According to an example embodiment, a data analysis device including first data analysis devices distributed within a network and a centralized second data analysis device may include: a communication interface, comprising communication circuitry, configured to collect mobility data of a UE from mobility management devices in the network, and at least one processor, comprising processing circuitry, individually and/or collectively, configured to preprocess the mobility data, and apply the preprocessed mobility data to the neural network-based prediction model to train the prediction model to predict base stations serving a target location to which the UE is expected to move, and the communication interface may be configured to transfer the base station list predicted by the trained prediction model and identification information of the UE to the mobility management devices.

According to an example embodiment, a mobility management device may include: a communication interface, comprising communication circuitry, configured to transmit mobility data of a UE to a first data analysis device distributed within a network, the first data analysis device including a trained neural network-based prediction model, and receive a base station list including base stations serving a target location to which the UE is expected to move, predicted by the first data analysis device by the prediction model based on the mobility data, and at least one processor, comprising processing circuitry, individually and/or collectively, configured to determine a target base station to perform per-level paging of multi-level paging among the base stations and perform the multi-level paging for the UE by the target base station.

While the disclosure has been illustrated and described with reference to various example embodiments, it will be understood that the various example embodiments are intended to be illustrative, not limiting. It will be further understood by those skilled in the art that various changes in form and detail may be made without departing from the true spirit and full scope of the disclosure, including the appended claims and their equivalents. It will also be understood that any of the embodiment(s) described herein may be used in conjunction with any other embodiment(s) described herein.

What is claimed is:

1. A method of operating a data analysis device including first data analysis devices distributed within a network and a centralized second data analysis device, the method comprising:
the first data analysis devices collecting mobility data of a user equipment (UE) from mobility management devices in the network;
the second data analysis device preprocessing the mobility data;
the second data analysis device applying the preprocessed mobility data to a neural network-based prediction model to train the prediction model to predict base stations serving a target location to which the UE is expected to move; and
transferring the trained prediction model and identification information of the UE to the first data analysis devices.

2. The method of claim 1, wherein
the mobility data comprises:
any one or a combination of, location information on a location to which the UE has moved in an active mode in which the UE performs communication, a first elapsed time that the UE is in the active mode, and a second elapsed time that the UE is in an idle mode in which the UE does not perform the communication, and the location information comprises:
any one or a combination of, identification information of the UE, information on a first base station corresponding to a first location from which the UE has departed in the active mode, and information on a second base station corresponding to a second location at which the UE has arrived by moving from the first location in the active mode.

3. The method of claim 1, wherein
the preprocessing of the mobility data comprises:
dividing the mobility data according to the identification information of the UE to generate a continuous sequence;
segmenting the continuous sequence into a plurality of unit sequences comprising location information corresponding to fixed time units; and
configuring the plurality of unit sequences into a batch for training and evaluating the prediction model, based on a movement path of the UE during the first elapsed time that the UE is in the active mode and a target location of the UE during the second elapsed time that the UE is in the idle mode.

4. The method of claim 3, wherein
the configuring of the plurality of unit sequences into the batch comprises:
setting first unit sequences of the plurality of unit sequences belonging to the first elapsed time as an input for training the prediction model;
setting second unit sequences of the plurality of unit sequences belonging to the second elapsed time as a label for evaluating the prediction model; and
configuring information comprising the identification information of the UE, the second elapsed time, the movement path of the UE during the first elapsed time, and the target location of the UE after the second elapsed time into the batch.

5. The method of claim 1, wherein
the training comprises:
training the prediction model to predict the base stations serving the target location using mobility data sampled over a fixed time interval and the first elapsed time that the UE is in the active mode.

6. The method of claim 1, wherein
the prediction model comprises:
a stacked deep neural network (DNN) configured to receive the preprocessed mobility data as input and learn spatiotemporal features of a mobility of the UE; and
fully connected layers configured to output a base station list comprising a probability that the UE is at each base station from an output of the stacked DNN, and the stacked DNN comprises
an input layer comprising DNN cells, and hidden layers,
wherein
in response to previous location paths over the fixed time interval of the UE, and the second elapsed time that the UE is in the idle mode being applied to the input layer, the hidden layers learn the target location to which the UE is expected to move in the second elapsed time based on the previous location paths.

7. The method of claim 6, wherein
the data analysis device is configured to:
align the probability that the UE is located at each base station output through the fully connected layers, and output the base station list comprising base stations corresponding to a predetermined percentage of the aligned probabilities.

8. A method of operating a mobility management device, the method comprising:
transmitting mobility data of a user equipment (UE) to a first data analysis device distributed within a network, the first data analysis device comprising a neural network-based trained prediction model;
receiving a base station list comprising base stations serving a target location to which the UE is expected to move, predicted by the first data analysis device by applying the mobility data to the prediction model;
determining a target base station to perform per-level paging of multi-level paging among the base stations comprised in the base station list; and
performing the multi-level paging for the UE by the target base station.

9. The method of claim 8, wherein
the determining of the target base station comprises:
in response to it being determined that the UE is not present in a cell of a last known base station in an active mode,
determining the target base station among the base stations comprised in the base station list according to a paging service type corresponding to the UE, and
the determining of the target base station comprises:
determining which paging service type is the paging service type corresponding to the UE among a first service type (iPRS) for reduced signaling and a second service type (iPRD) for reduced delay; and
adjusting a ratio of a first target base station used for level 1 paging and a second target base station used for level 2 paging among the base stations, according to the determined paging service type.

10. The method of claim 9, wherein
the determining of which paging service type comprises:
determining which of the paging service types is the paging service type corresponding to the UE based on at least one of a service type and a billing policy corresponding to the UE,
and
the adjusting of the ratio of the first target base station and the second target base station comprises:
in response to the determined paging service type being the first service type, determining the last known base station where the UE is in the active mode to be the first target base station; and
determining the base stations comprised in the base station list to be the second target base station.

11. The method of claim 9, wherein
the adjusting of the ratio of the first target base station and the second target base station comprises:
in response to the determined paging service type being the second service type, determining a number of base stations equal to a first ratio of the base stations comprised in the base station list to be the first target base station; and
determining a number of base stations equal to a second ratio of the remainder excluding the first ratio of the base stations comprised in the base station list to be the second target base station.

12. The method of claim 9, wherein
the performing of the multi-level paging comprises:
performing the level 1 paging by the first target base station; and
performing the level 2 paging by the second target base station.

13. The method of claim 9, wherein
the mobility data comprises:
any one or a combination of, location information on a location to which the UE has moved in an active mode in which the UE performs communication, a first elapsed time that the UE is in the active mode, and a second elapsed time that the UE is in an idle mode in which the UE does not perform the communication.

14. A data analysis device including first data analysis devices distributed within a network and a centralized second data analysis device, comprising:
a communication interface, comprising communication circuitry, configured to collect mobility data of a user equipment (UE) from mobility management devices in the network; and
at least one processor, comprising processing circuitry, individually and/or collectively, configured to: preprocess the mobility data, and apply the preprocessed mobility data to a neural network-based prediction model to train the prediction model to predict base stations serving a target location to which the UE is expected to move,
wherein
the communication interface is configured to:
transfer a base station list predicted by the trained prediction model and identification information of the UE to the mobility management devices.

15. A mobility management device, comprising:
a communication interface, comprising communication circuitry, configured to transmit mobility data of a user equipment (UE) to a first data analysis device distributed within a network, the first data analysis device comprising a trained neural network-based prediction model, and receive a base station list comprising base stations serving a target location to which the UE is expected to move, predicted by the first data analysis device by the prediction model based on the mobility data; and
at least one processor, comprising processing circuitry, individually and/or collectively, configured to determine a target base station to perform per-level paging of multi-level paging among the base stations and perform the multi-level paging for the UE by the target base station.
